(19) United States
(12) Patent Application Publication
(10) Pub. No.: US 2007/0216683 A1
(43) Pub. Date: Sep. 20, 2007

(54) Method and apparatus for displaying a third variable in a scatter plot

(75) Inventors: Roman Navratil, Prague (CZ); Pavel Buran, Prague (CZ); Wendy K. Foslien, Minneapolis, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/378,957

(22) Filed: Mar. 17, 2006

(51) Int. Cl. G06T 11/20

(52) U.S. Cl. 345/440

(57) ABSTRACT

A scatter plot showing the relationship of one variable as a function of a second variable on an x-y graph is enhanced by displaying information about a third variable by means of the shade or color of the data points comprising the scatter plot in correlation with the value of that third variable corresponding to the particular data point.

### FIELD OF THE INVENTION

The invention pertains to the fields of data visualization and data analysis, such as the displaying of process data. More particularly, the invention pertains to the displaying of data pertaining to multiple variables in a scatter plot.

### BACKGROUND OF THE INVENTION

Scatter plots and trend plots are commonly used as data analysis tools in many fields of academic, industrial, and scientific pursuit.

A scatter plot is a graph used to visually display and compare two sets of related quantitative, or numerical, data by displaying a finite number of points, each having a coordinate on a horizontal axis and a vertical axis. For example, if one wished to study the effects of temperature at a certain location in a manufacturing assembly line for an integrated circuit (for example, inside of a vapor deposition chamber in which a doped semiconductor layer is being deposited on a semiconductor wafer substrate) on the final dopant level in that layer at the end of the fabrication line, one would take temperature measurements inside the chamber as each semiconductor wafer was in the chamber. These temperature measurements would comprise the first of the two data sets. One also would test the dopant level of that layer in each of those wafers at the end of the fabrication process. These dopant level measurements would comprise the second data set. Then, one would set up a scatter plot, assigning “temperature” to the horizontal (or x) axis, and “dopant level” to the vertical (or y) axis or vice versa. A wafer that was in the chamber when the chamber temperature was 600° C. and that had a final dopant level of 1.3×10¹³ carriers per cubic centimeter in the layer of interest would be represented by a single dot on the scatter plot at the point (600, 1.3×10¹³) in Cartesian coordinates. The scatter plot of all the wafers in the study would enable the analyst to obtain a visual comparison of the two sets of data and to determine what kind of relationship there might be between them.

More generally, a scatter plot shows the position of all of the cases in an x-y coordinate system. The independent variable is usually plotted on the x-axis, or the horizontal axis. The dependent variable is usually plotted on the y-axis, or the vertical axis. A dot or data point in the body of the chart represents the intersection of the data on the x and y axes. As used herein, the term “data point” is used to refer to a data element having one or more dimensions. Data points may relate to any type of data such as system state data, event data, outcomes, business events, etc.

A trend plot also is an x-y graph in which one variable is plotted on the y axis against another variable on the x axis. The x axis usually represents a sequence variable that is monotonically increasing. It is very common for the x axis to represent time in a trend plot. However, it need not be time. A trend plot may reasonably be considered to be a specific type of scatter plot in which, for any given value of x, there is only one value of y. Therefore, a trend plot usually has the limitation of a one-to-one mapping of the variable on the y axis to the variable on the x axis and, hence, usually comprises a continuous curve. However, if the variable corresponding to the y axes has only discrete values (e.g., on/off), the curve will have discrete value changes.

As its name implies, however, a scatter plot, in general, does not have the limitation of one to one mapping. That is, for any given x axis position/measurement (e.g., temperature in the vapor deposition chamber), there can be any number of data points on the y axis (e.g., dopant levels in the layer of the wafer).

Scatter plots and trend plots are commonly used in connection with analyzing process data collected within manufacturing facilities and other types of plants, assembly lines, and the like in order to monitor the performance of the plant, assembly line, or other process (hereinafter collectively system). Such data may be collected by one or more sensors disposed throughout the system, and, particularly, within the manufacturing equipment. Common types of process data sets include temperatures, flow rates, pressures, voltages, currents, velocities, etc. The process data may comprise data about the system itself, e.g., temperatures or pressures within certain equipment, or about the product that is being produced by the system, e.g., temperature of a part being manufactured, the pressure of a fluid being manufactured, the dopant level in a layer of an integrated circuit wafer, etc.

Process data also may include more complex data about the product that is being produced, such as some type of objective or subjective measure of quality of the product, the number of products per unit time being produced, or even a quality or abnormality factor that must be calculated from other measured or observed phenomena. Process data might even comprise financial data, such as energy cost per unit produced.

In fact, process data can comprise almost any measurable or computable characteristic of a system or product.

Accordingly, manufacturing plants and other systems usually comprise a number of sensors for collecting process data at periodic time intervals (or continuously). The data from these sensors is sent to a computer equipped with software for storing and presenting the process data collected from the sensors (or computed from the data obtained by the sensors or other sources, as the case may be) in a human readable form, such as a trend plot or scatter plot, so that the persons responsible for the operation of the system can determine important information about the system or the product being produced by the system that will help them maintain and run the system.

In a typical scenario, an operator will first look at a series of trend plots that show a plurality of variables plotted in a single display on a plurality of y axes against time on a single x-axis in order to see changes in those variables over time and obtain a feel for how those plurality of variables correlate with each other and with time over the displayed time period.

FIG. 1, for instance, is an exemplary trend plot simultaneously showing eight different process variables plotted against time. All eight variables are plotted against the same single time scale on the x axis so that the eight variables can be compared to each other easily. In the particular example illustrated in FIG. 1, the uppermost plot 12 pertains to a discrete (or categorical) variable having two possible values (e.g., on-off). In this particular example, the variable represented in plot 12 is whether the product being produced did or did not meet a certain quality criterion, such as a minimum dopant level for a semiconductor substrate. The seven remaining variables represented by lines 14, 16, 18, 20, 22, 24, and 26 are all temperatures taken at different locations in the system.

As noted above, trend plots can be very useful to the operators of systems in terms of helping them understand how certain variables or characteristics of the system affect other variables or characteristics of the system or the product that it is producing. For instance, it is readily apparent in the trend plot of FIG. 1 that those instances where the product quality became unacceptable as illustrated by areas 27, 28, 29, 30, 31, and 32 in uppermost plot 12 seem to correlate somewhat with the temperature spikes measured in plots 14,18, 22 and/or 24.

However as is also apparent from FIG. 1, the data in the trend plot is not conclusive as to exactly how the temperature spikes detected by any one of the corresponding temperature sensors correlates to the product quality as illustrated in plot 12 or how the temperature detected by any one sensor correlates to the temperature detected by any other one of the sensors.

Accordingly, an operator or analyst may then look at scatter plots that plot some or all of those y-axis variables (e.g., temperatures 1 through 7) against some or all of the other y-axis variables, e.g., the temperature at sensor 1 compared to the temperature at sensor 2 at each discrete measurement time, the temperature at sensor 1 compared to the temperature at sensor 3, the temperature at sensor 2 compared to the temperature at sensor 3, etc. This can help the operator better understand possible relationships and correlations between those variables.

FIG. 2 is an exemplary matrix 201 of scatter plots, generated from the same data displayed in FIG. 1. Each scatter plot plots the temperatures measured at one of the seven temperature sensors against the temperatures measured at another one of the seven temperature sensors from FIG. 1. The quality variable represented in line 12 in FIG. 1 is not plotted in any of the scatter plots in FIG. 2. Note that plotting all permutations of the seven temperature variables against each other (including itself) would result in a 7 by 7 matrix of 49 scatter plots. In order not to obfuscate the principles being discussed, only a roughly 3 by 4 portion of the matrix is shown, illustrating about 12 of those scatter plots. Also note that, when the temperatures measured at one sensor are scatter plotted against themselves, it will always result in a scatter plot of a straight line at 45° (assuming the x and y scales are the same), as illustrated by scatter plot 209, which plots the temperature measured at temperature sensor 4 versus itself.

It is an object of the present invention to provide an improved method and apparatus for displaying process data.

It is another object of the present invention to provide an improved method and apparatus for displaying scatter plots that provides more information than in the prior art.

It is a further object of the present invention to provide an improved method and apparatus for displaying a third variable in a scatter plot.

### SUMMARY OF THE INVENTION

In accordance with the principles of the present invention, a scatter plot showing the relationship of one variable as a function of a second variable on an x-y graph is enhanced by displaying information about a third variable in the scatter plot by means of the shade or color of the data points comprising the scatter plot. Specifically, the shade or color of each data point represents the value of that third variable corresponding to the particular data point. In one embodiment of the invention, this third variable is a unidirectional variable such as time, and its value is correlated to color in accordance with the continuously variable spectrum of color of visible light (visible light being continuously variable in color from violet to red as a function of its wavelength). Thus for example, violet would correspond to the earliest time represented, whereas red would correspond to the latest time represented on the plot. Blue, green, yellow, and orange and all the infinite variations therebetween would represent values between the earliest and latest time values in the scatter plot. In another embodiment, the variable could be represented by varying the intensity of a single color.

### BRIEF DESCRIPTION OF THE DRAWINGS

FIG. 1 is a diagram illustrating a trend plot showing the trend of a plurality of process data variables as a function of time in accordance with the prior art.

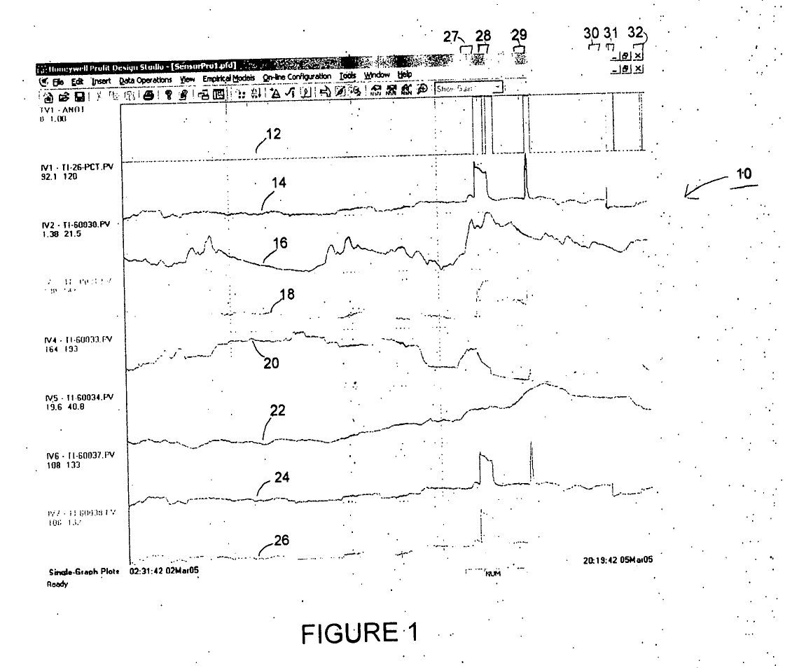

FIG. 2 is a diagram illustrating a matrix of scatter plots, each plotting two of the variables from the trend plots of FIG. 1 against each other in various permutations in accordance with the prior art.

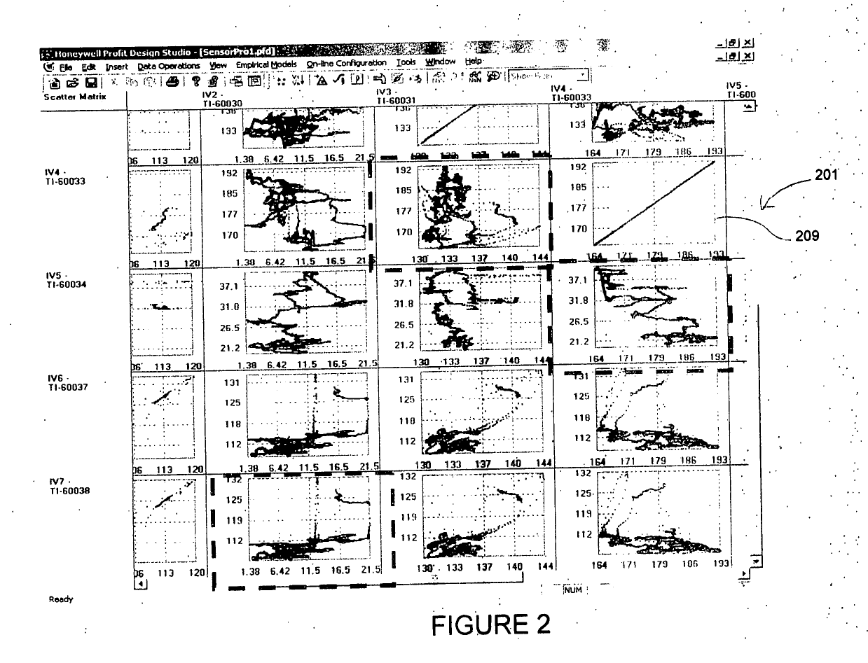

FIG. 3 is a diagram illustrating a scatter plot showing three variables plotted against each other in a three-dimensional representation.

FIG. 4 is a diagram illustrating a scatter plot in accordance with the principles of the present invention showing two variables plotted against each other on the x and y axes of the scatter plot with a third variable represented by the color of the data points.

FIG. 5 is another diagram illustrating another scatter plot in accordance with the principles of the present invention showing two variables plotted against each other on the x and y axes of the scatter with a third variable represented by the color of the data points.

FIG. 6 is diagram illustrating yet another scatter plot in accordance with the principles of the present invention showing two variables plotted against each other on the x and y axes of the scatter with a third variable represented by the color of the data points.

### DETAILED DESCRIPTION OF THE INVENTION

As noted above, the combined use of trend plots and scatter plots can provide a large amount of valuable information about a system and/or a product being produced by the system. However, the sheer number of different variables that might affect operation of the system, the quality or other characteristics of the product being produced by the system, and/or each other can leave an operator desiring more integrated information than can be provided by traditional trend and scatter plots. Furthermore, it would not be uncommon for a single scatter plot to show several tens of thousands of data points. Merely as one example, it would not be uncommon for an operator to view a scatter plot showing two variables plotted against each other in which the sensors that detect those variables recorded values every 10 seconds and the scatter plot shows the two variables plotted against each other over a one week period. Such a plot would show 60,480 data points.

It is envisioned that showing a third variable or third dimension of data on a scatter plot potentially can be very useful to an operator or data analyst. For instance, it is contemplated that additionally displaying in a scatter plot the time at which the data points were recorded may be extremely useful information to see in a single visual display. Another third dimension variable that could provide very useful additional information in a scatter plot is an abnormality value, e.g., the value corresponding to the variation of the final product from a desired quality measurement or any reasonable Key Performance Indicator (KPI) of the product.

Such additional information in a scatter plot would help operators analyze root causes of product abnormalities or variations in KPls. For instance, it may help an operator determine that variations in abnormality (or a KPI) correlate to a relationship between two other values, such as variations in temperature between a first point and a second point in the system.

The present invention addresses this issue by providing a third dimension of data in a scatter plot in a manner that permits an observer to easily perceive and understand the relationships between the three variables in the scatter plot.

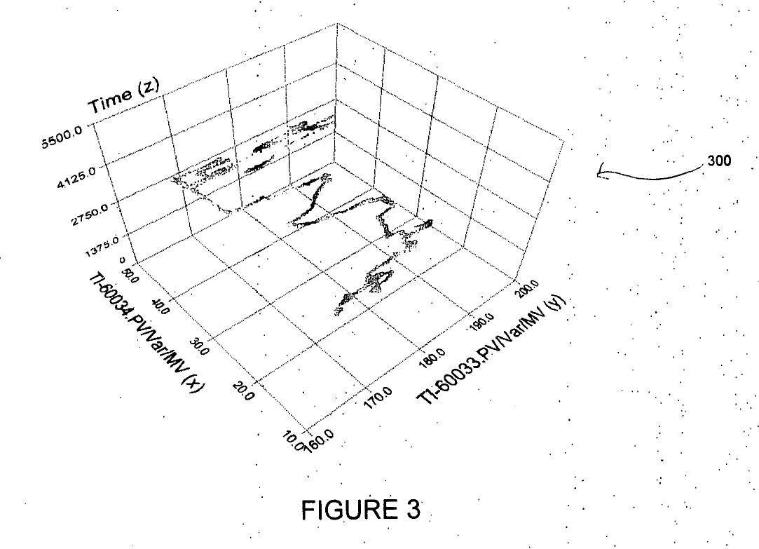

FIG. 3 is a diagram illustrating a three-dimensional display 300 showing a perspective view of a three-dimensional graph comprising x, y, and z coordinate axes. The x and y axes correspond to the first and second variables as in a normal scatter plot. Let us say they are temperature 1 and temperature 2 measured at two different points in the system. The z axis corresponds to a third value. Let us say the third value is time.

This solution presents some additional information and can be quite useful. However, it is not particularly visually appealing because, in many instances, the perspective view will cause some of the data to be obscured. Particularly, the perspective view will cause some data points to occlude other data points. Furthermore, as should be apparent from FIG. 3, the time value represented along the z axis is somewhat difficult to perceive.

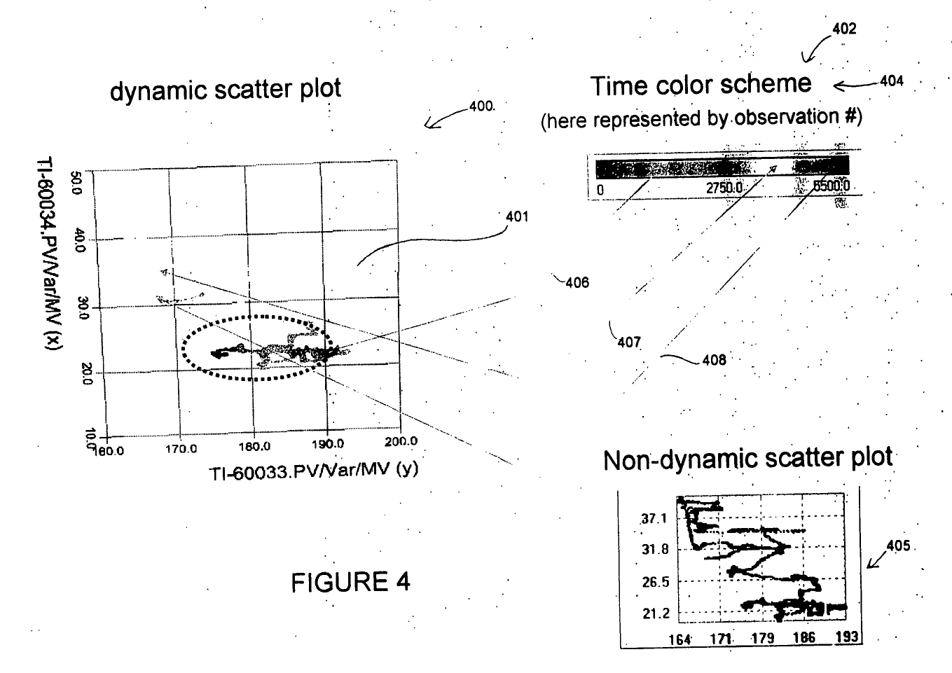

FIG. 4 is a diagram illustrating a scatter plot 400 that displays information as to the correlation between three variables in accordance with the principles of the present invention. Particularly, the diagram comprises an x, y, graph 401 as in a standard scatter plot in which the first variable is represented by the y axis position of the data point and the second variable is represented by the x axis position of the data point. In this example, the y axis corresponds to the temperature measurements at a first temperature sensor, hereinafter T₃₄ and the x axis corresponds to the temperature measurement at a second temperature sensor, hereinafter T₃₃. A third variable is represented by the color of the data points. The third variable may be any variable. However, it is contemplated that the invention will be particularly useful to users when the third variable is a uni-directional variable, such as time. Other unidirectional variables might include the batch number of a product being produced. On the other hand, it also is contemplated that the invention may be particularly beneficial when the third value is a KPI or abnormality value (which are not unidirectional variables).

In one preferred embodiment, this third variable is correlated to color in accordance with the continuously variable spectrum of color of visible light (visible light being continuously variable in color from red to violet as a function of its wavelength). Thus for example, violet would correspond to the lowest value of the variable in question, whereas red would correspond to the highest value of that variable. Blue, green, yellow, and orange and all the infinite variations therebetween would represent values between the lowest and highest values of that variable.

Although it is assumed that most people are familiar with the change of color along the wavelength spectrum of visible light, it will often be preferable to provide a key 402 displaying the meaning of the color, e.g., the value to which each particular color corresponds Oust as the values of the variables represented by the x and y positions of the data points normally are displayed along the x and y axes). For instance, to the right in FIG. 4 is a key 402 showing how the color of a data point corresponds to the time variable. In this particular example, and as is common, time is actually measured in terms of a discrete sample number. That is, in this example, the time scale runs from sample number 0 to sample number 5500, wherein each sample number corresponds to a specific time. For example, measurement of the two variables corresponding to the x and y axes are sampled every 10 seconds for approximately 2 shifts (16 hours) starting with sample 0 and ending with sample 5500. More particularly, the key shows the full spectrum of visible light from violet at the left to red at the right and includes a scale from time 0 to time 5500 samples. Furthermore, in a preferred embodiment of the invention, the name of the variable 404 is shown in or next to the key 402.

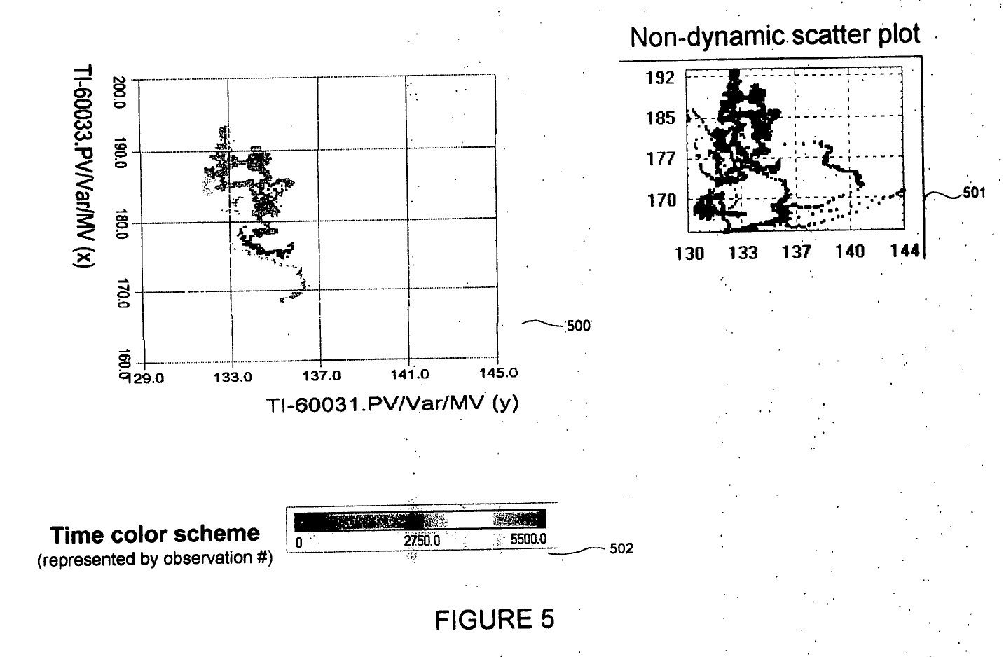

In FIG. 4, the key 402 is shown removed from screen shot in order to more easily demonstrate the general time trends observable in the plot (using reference lines 406, 407, and 408, as discussed below). However, the key 402 should normally appear within the display 400, such as illustrated in FIG. 5 discussed further below.

For purposes of exposition and comparison, a conventional scatter plot 405 appears in the lower right hand portion of FIG. 4 showing only two dimensions of data, namely, temperature at sensor 33 and temperature at sensor 34.

Note that the three dimensional scatter plot of FIG. 4 clearly illustrates to the observer certain time-based trends in the two observed temperatures that cannot be discerned from the conventional two dimensional scatter plot. For instance, referring to reference line 406, there clearly is a cluster of data points from about time 0 to about time 2750 where T₃₄ remained relatively constant at about 20-25° while T₃₃ varied between 175-195°. Then, referring to the portion of the plot referred to by reference line 407, between about time 2750 and time 5000, T₃₄ started to rise upwards of 40° and then started coming back down to about 32° while T₃₃ started generally trending downward towards about 164° with a temporary increase from about 172° back up to about 183° approximately in the middle of that time period. Finally, referring to the portion of the plot referred to by reference line 408, from about time 5000 through time 5500, T₃₄ remained quite constant between about 30° and 32° while T₃₃ varied from about 167° to 184°.

In other contemplated embodiments of the invention, rather than using the color of the data point to represent the third variable, other characteristics can be used, such as shape, size, or fill pattern of the data point. Even further, the intensity of a single color can be varied to represent the value of the third variable. In one specific example, grayscale variations can be used to represent the variable values.

It is contemplated that some of the variables that commonly will be useful to display by means of color in accordance with the principles of the present invention include variables such as time, measurements of data normality or abnormality, key performance indicators (KPls), product quality, quality of the input material, and energy price for applications in utilities.

FIG. 5 illustrates another scatter plot 500 generated in accordance with the principles of the present invention. Like FIG. 4, this plot also shows two temperature measurements, this time T₃₃ versus T₃₁, plotted against the y and x axes, respectively, with color again representing the time index (or, more accurately, sample number).

In the process industry, the term “dynamic measurement” refers to time dependent measurements. Therefore, the inventive scatter plots of FIGS. 4 and 5 are herein termed dynamic scatter plots.

A conventional (or non-dynamic) scatter plot 501 showing only the two variables T₃₃ and T₃₁ plotted against the x and y axes is shown at right for purposes of comparison and particularly so that the additional information provided by the present invention can be seen relative to a conventional scatter plot not including such additional information.

The key 502 showing how the color corresponds to time (or sample number) appears near the bottom of the display screen.

Note again that time-based trends are clearly observable in the plot. For example, between about time indexes 3600 and 4500, the two temperatures are widely scattered, whereas they are much more uniform before and after that period.

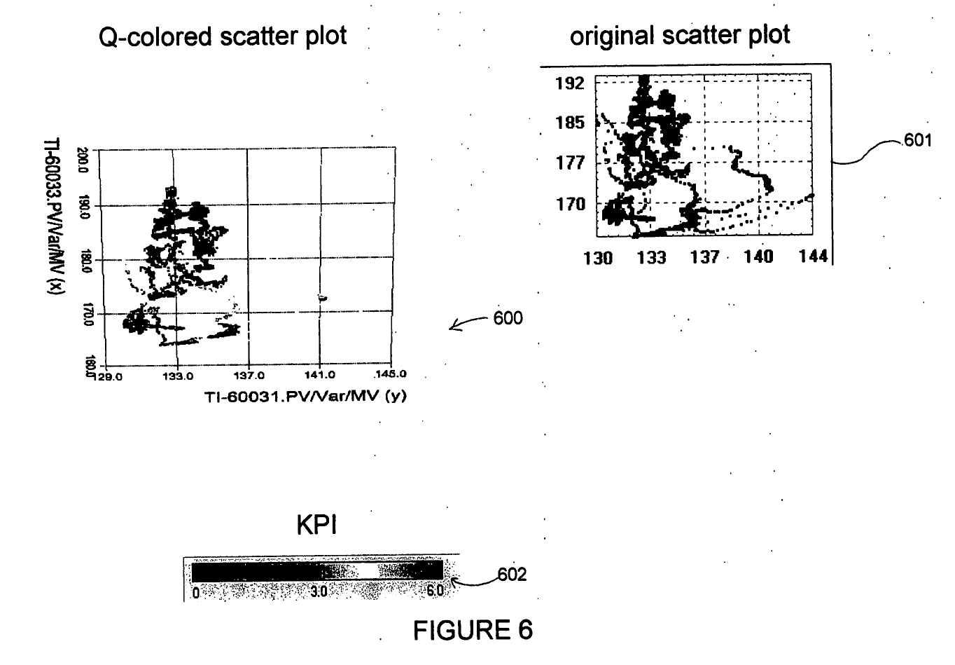

FIG. 6 illustrates yet another scatter plot 600 generated in accordance with the principles of the present invention. Like FIG. 5, this plot also shows T₃₃ versus T₃₁ plotted against the y and x axes, respectively. However, in this plot, color represents some Key Performance Indicator, let us say an abnormality rating ranging from 0.0 to 6.0,wherein a value of 0.0 represents a product exactly on-spec and a value of 6.0 represents a product very far off-spec. Note that, in our terminology this is not a “dynamic” scatter plot since the third dimension is not time.

A conventional scatter plot 601 showing only the two temperatures plotted against the x and y axes is shown at right. The key 602 showing how the color corresponds to the KPI appears near the bottom of the display screen.

Note again that clear trends are observable on the plot. Particularly, note that when temperature T31 is over about 137°, the product is quite far off-spec. On the other hand, variations in temperature T33 within the observed temperature range of about 164° to 194° do not appear to have a significant impact on product abnormality.

This typically would be extremely useful information to the operator of a manufacturing facility as well as a process analyst examining the productivity of the manufacturing plant.

By displaying the additional dimension of data together with the two dimensions of data of a conventional scatter plot, an operator or engineer can immediately relate this new variable to the other two variables.

The third dimension of data can alternately be represented by some other characteristic of the data point. For instance, the shape, size or fill pattern of the data point can vary as a function of the third variable. Merely as one example, the shape of a data point can be a triangle for the lowest possible value of the variable that it represents and increase in number of sides or facets as the value increases until it approaches a circle (an infinitely sided two dimensional shape) for the highest possible values. Thus, the data points would change from triangles to squares to pentagons to hexagons, etc. as the value of the variable increased. This solution could have great advantage in situations where hardcopies of scatter plots need to be generated and color printers are not readily available. However, this solution probably would be most helpful only when there are relatively few data points displayed in a plot.

Software for generating trend plots from sensor input information is widely available on the market. Adapting such software to incorporate the principles of the present invention would be a simple matter for a software developer.

It would be desirable to provide some additional graphical user interfaces (GUIs) or additional user input parameters on existing GUIs that, for instance, permit the user to turn the features of the present invention on and off, for selection of the variable is to be represented by means of the color gradient, for selection of the color gradient type, and also for selection of the chart background color. Chart background color should enable for good visibility of points displayed using a specific color gradient.

Having thus described a few particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

1. A computer program product recorded on computer readable medium for generating a scatter plot comprising:
computer executable instructions for generating a graph having an x-axis and a y axis and plotting a plurality of data points on said graph representing a first variable and a function of a second variable, wherein, for each data point, a corresponding value of said first variable is represented by said data point's position relative to said x axis and a corresponding value of said second variable is represented by said data points position relative to the y axis; and
computer executable instructions for representing a value of a third variable corresponding to each said data point by displaying each said data point in a color correlated to a corresponding value of said third variable.

2. The computer program product of claim 1 wherein said third variable is a unidirectional variable.

3. The computer program product of claim 2 wherein said third variable is time.

4. The computer program product of claim 1 further comprising computer executable instructions for displaying a key illustrating information about said third variable.

5. The computer program product of claim 4 wherein said information about said third variable comprises information disclosing a correlation between said color and a value of said third variable.

6. The computer program product of claim 5 wherein said information about said third variable further comprises the identity of said third variable.

7. The computer program product of claim 1 wherein said third variable is represented by continuously variable colors within the visible light spectrum and wherein said color correlates to said third value in relationship with a wavelength corresponding to said color.

8. A computer program product recorded on computer readable medium for generating a scatter plot comprising:
computer executable instructions for generating a graph having an x-axis and a y axis and plotting a plurality of data points on said graph representing a first variable and a function of a second variable, wherein, for each data point, a corresponding value of said first variable is represented by said data point's position relative to said x axis and a corresponding value of said second variable is represented by said data points position relative to the y axis; and
computer executable instructions for representing a value of a third variable corresponding to each said data point by displaying each said data point with a characteristic correlated to a corresponding value of said third variable.

9. The computer program product of claim 8 wherein said characteristic is color.

10. The computer program product of claim 8 wherein said characteristic is shape.

11. The computer program product of claim 8 wherein said characteristic is a size of said data point.

12. The computer program product of claim 8 wherein said characteristic is a pattern of said data point.

13. The computer program product of claim 8 wherein said characteristic is a shade of said data point.

14. The computer program product of claim 8 wherein said characteristic is an intensity of a color of said data point.

15. A method of generating a scatter plot comprising:
generating a graph having an x-axis and a y axis and plotting a plurality of data points on said graph representing a first variable and a function of a second variable, wherein, for each data point, a corresponding value of said first variable is represented by said data point's position relative to said x axis and a corresponding value of said second variable is represented by said data points position relative to the y axis; and
representing a value of a third variable corresponding to each said data point by displaying each said data point in a color correlated to a corresponding value of said third variable.

16. The computer program product of claim 15 wherein said third variable is a unidirectional variable.

17. The computer program product of claim 16 wherein said third variable is time.

18. The computer program product of claim 15 further comprising the step of displaying a key illustrating information about said third variable.

19. The computer program product of claim 18 wherein said information about said third variable comprises information disclosing a correlation between said color and a value of said third variable.

20. The computer program product of claim 19 wherein said information about said third variable further comprises the identity of said third variable.
